(19) United States
(12) Patent Application Publication
(10) Pub. No.: US 2002/0141427 A1
(43) Pub. Date: Oct. 3, 2002

(54) Method and apparatus for a traffic optimizing multi-stage switch fabric network

(76) Inventor: Gary L. McAlpine, Banks, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/819,675

(22) Filed: Mar. 29, 2001

(51) Int. Cl. H04L 12/56

(52) U.S. Cl. 370/413; 370/419

(57) ABSTRACT

A switch element is provided that includes a plurality of input interfaces to receive a plurality of output interfaces. A buffer may couple to the input interfaces and the output interfaces. The buffer may include a plurality of multi-dimensional array of output queues to store the data. Each one of the multi-dimensional output queues may be associated with a separate one of the output interfaces. An arbiter device may select one of the output queues for transmission based on transmit pressure information.

### FIELD

The invention generally relates to multi-stage switch fabric networks and more particularly relates to a method and apparatus for controlling traffic congestion in a multi-stage switch fabric network.

### BACKGROUND

It is desirable to build high speed, low cost switching fabrics by utilizing a single switch chip. Each chip may include multiple full duplex ports (for example, eight to sixteen full duplex ports are typical) meaning multiple input/output ports on a respective chip. This typically enables eight to sixteen computing devices to be connected to the chip. However, when it is desirable to connect a greater number of computing devices, then a plurality of chips may be connected together using a multistage switch fabric network. Multi-stage switch fabric networks include more than one switch element so that traffic flowing from a fabric port to another may traverse through more than one switch element.

However, one problem with multi-stage switch fabrics is traffic congestion caused by an excessive amount of traffic (i.e., data packets) trying to utilize given links within the multi-stage switch fabric. Overloaded links can cause traffic to back up and fill switch queues to the point that traffic not utilizing the overloaded links starts getting periodically blocked by traffic utilizing the overloaded links (commonly referred to as blocking). This degrades the operation of the network and thus it is desirable to control the traffic congestion within the multi-stage switch fabric.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the present invention are limited only by the terms of the appended claims.

The following represents brief descriptions of the drawings wherein like reference numerals represent like elements and wherein:

FIGS. 1A-1C show different topologies of a switch fabric network;

FIG. 2 shows a switch architecture according to an example arrangement;

FIG. 3 shows a first switch element and a second switch element and the transmission of a feedback signal according to an example arrangement;

FIGS. 4A-4C show different levels of the priority queues;

FIG. 5 shows four switch elements and the transmission of feedback signals according to an example arrangement;

FIG. 6 shows data propagation along a signal line according to an example arrangement;

FIG. 7 shows flow control information according to an example arrangement;

FIG. 8 shows a switch architecture according to an example embodiment of the present invention;

FIG. 9 shows a first switch element and a second switch element according to an example embodiment of the present invention;

FIG. 10 shows the functionality of an arbiter device according to an example embodiment of the present invention;

FIG. 11 shows an example pressure function according to an example embodiment of the present invention; and

FIG. 12 shows an example logical path priority function according to an example embodiment of the present invention.

### DETAILED DESCRIPTION

The present invention will now be described with respect to example embodiments. These embodiments are merely illustrative and are not meant to limit the scope of the present invention. That is, other embodiments and configurations are also within the scope of the present invention.

The present invention is applicable for use with different types of data networks and clusters designed to link together computers, servers, peripherals, storage devices, and communication devices for communications. Examples of such data networks may include a local area network (LAN), a wide area network (WAN), a campus area network (CAN), a metropolitan area network (MAN), a global area network (GAN), a storage area network and a system area network (SAN), including data networks using Infiniband, Ethernet, Fibre Channel and Server Net and those networks that may become available as computer technology develops in the future.

Data blocking conditions need to be avoided in order to maintain the quality of multiple classes of service (CoS) for communication through the multi-stage switch fabrics. The quality of certain classes of data, such as voice and video, may be highly dependent on low end-to-end latency, low latency variations, and low packet loss or discard rates. Blocking in the network components, such as switch fabrics, between source and destination, adversely affects all three. Non-blocking multi-stage switch fabrics may employ proprietary internal interconnection methods or packet discarding methods to alleviate traffic congestion. However, packet discarding is generally not an acceptable method in System Area Networks (SAN) and proprietary internal methods are generally fabric topology specific and not very scalable.

A blocking avoidance method will be described that can be employed to eliminate packet loss due to congestion in short range networks such as SANS, and significantly reduce packet discard in long range networks such as WANS. This mechanism may be cellular in nature and thus is inherently scalable. It may also be topology independent.

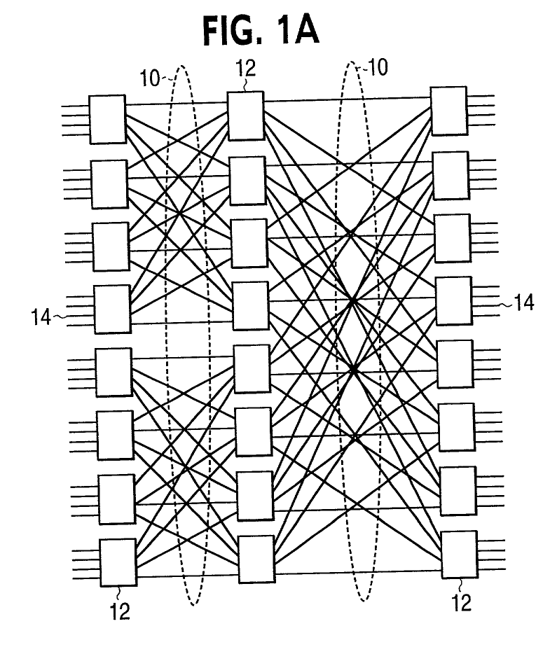

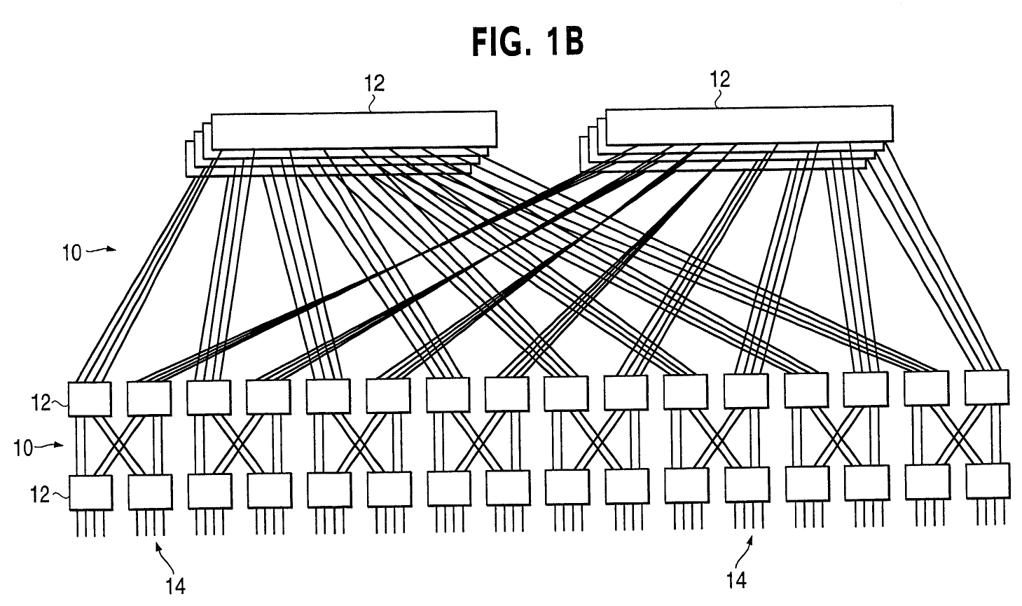

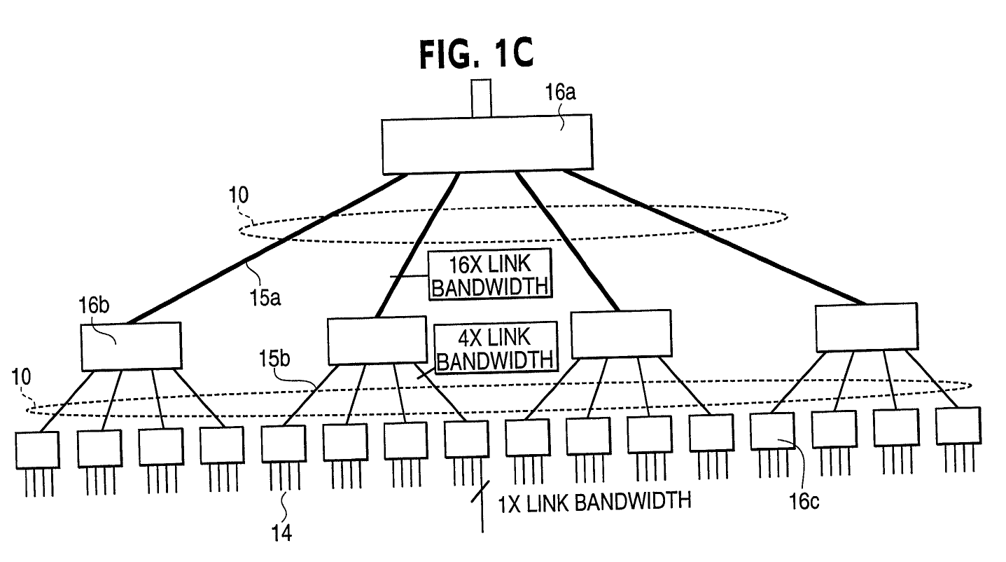

FIGS. 1A, 1B and 1C show three different fabric topologies for a switch fabric network. For example, FIG. 1A shows a butterfly switch fabric network that includes a fabric interconnect 10 and a plurality of switch elements 12. Each of the switch elements 12 may be a separate microchip. FIG. 1A shows a plurality of input/output signal lines 14 coupled to the switch elements. That is, FIG. 1A shows a 64 port butterfly topology that uses 24 eight port full duplex switch elements.

FIG. 1B shows a fat tree switch fabric network including the fabric interconnect 10 and the switch elements 12 that may be coupled as shown. FIG. 1B also shows the input/output signal lines 14 coupled to the switch elements. That is, FIG. 1B shows a 64 port fat tree topology using 40 eight port full duplex switch elements.

FIG. 1C shows a hierarchical tree switch fabric network having the fabric interconnect 10 and the switch elements 16a, 16b, 16c that may be coupled as shown in the figure. FIG. 1C also shows the input/output signal lines 14 coupled to the switch elements 16c. Fabric interconnect signals 15a and 15b are 16 times and 4 times the bandwidth of the input/output signals 14, respectively. More specifically, FIG. 1C shows a 64 port hierarchical tree topology using 5 port progressively higher bandwidth full duplex switch elements.

FIGS. 1A-1C show three different types of switch fabric topologies that may be used with embodiments of the present invention. These examples are provided merely for illustration purposes and do not limit the scope of the present invention. That is, other types of networks, connections, switch elements, inputs and outputs are also within the scope of the present invention.

While the switch fabric network may include one physical switch fabric, the switch fabric may perform different services depending on the class of the service for the data packets. Therefore, the switch fabric may support the different levels of service and maintain this different level of service throughout the fabric of switch elements. While the switch fabric network may include one physical switch fabric, the physical switch fabric may logically operate as multiple switch fabrics, one for each class of service.

As discussed above, one problem with switch fabrics is that congestion may build-up on the different switch elements when a large number of data packets attempt to exit the switch element. Disadvantageous arrangements may attempt to control the congestion by examining the overall switch fabric network and then controlling the information that enters into the switch fabric network. However, the switch fabric network may extend over a large geographical area and this method may therefore be unrealistic. Further disadvantageous arrangements may discard data packets or stop the flow of data packets into the network. This may necessitate the retransmission of data which may slow down operation of the network.

The system may act locally on one chip (or switch element) so as to control the traffic congestion at that chip and its neighboring chips (or switch elements) without having knowledge of the entire switch fabric network. However, the chips (or switch elements) may cooperate together to control the overall switch fabric network in a more productive manner.

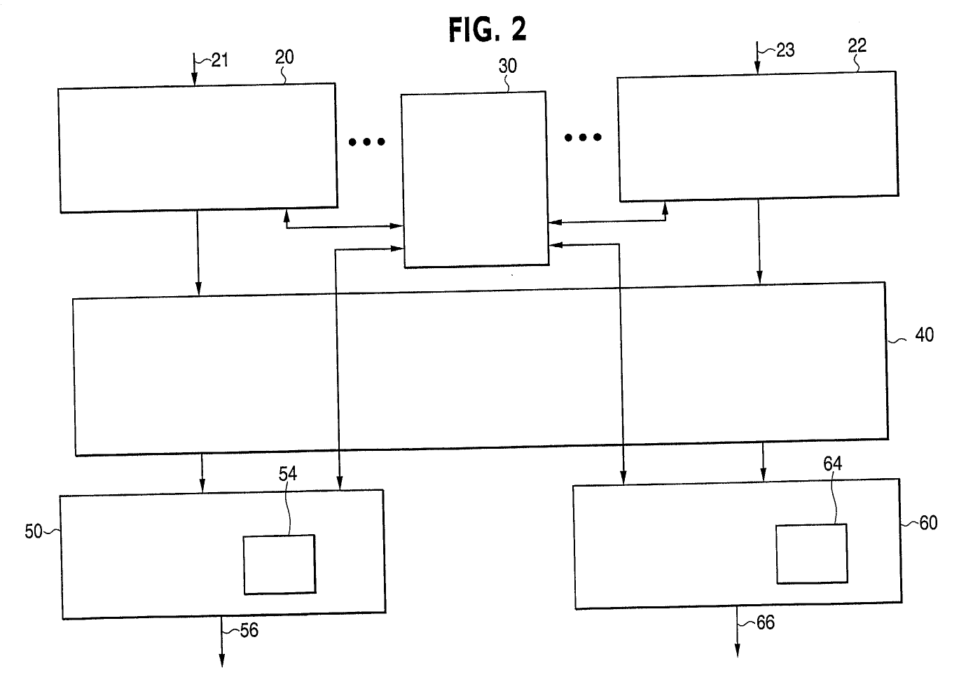

FIG. 2 shows an architecture of one switch element according to an example arrangement. This figure and its discussion are merely illustrative of one example arrangement described in U.S. patent application Ser. No. 09/609,172, filed Jun. 30, 2000 and entitled “Method and Apparatus For Controlling Traffic Congestion In A Switch Fabric Network.”

Each switch element may include a plurality of input blocks and a plurality of output blocks. FIG. 2 shows a first input block 20 and a second input block 22. Other input blocks are not shown for ease of illustration. FIG. 2 also shows a first output block 50 and a second output block 60. Other output blocks are not shown for ease of illustration. Each input block and each output block are associated with an input/output link. For example, a first input link 21 may be coupled to the first input block 20 and a second input link 23 may be coupled to the second input block 22. A first output link 56 may be coupled to the first output block 50 and a second output link 66 may be coupled to the second output block 60.

Each of the input blocks (including the first input block 20 and the second input block 22) may be coupled through a buffer (i.e., RAM) 40 to each of the output blocks (including the first output block 50 and the second output block 60). A control block 30 may also be coupled to each of the input blocks and to each of the output blocks as shown in FIG. 2.

Although not shown in FIG. 2, each of the input blocks may include an input interface coupled to the incoming link to receive the data packets and other information over the link. Each of the input blocks may also include a route mapping and input control device for receiving the destination address from incoming data packets and for forwarding the address to the control block 30. The control block 30 may include a central mapping RAM and a central switch control that translates the address to obtain the respective output port in this switch element and the output port in the next switch element. Further, each of the input blocks may include an input RAM interface for interfacing with the buffer 40. Each of the output blocks may include an output RAM interface for interfacing with the buffer 40 as well as an output interface for interfacing with the respective output link. The input blocks may also include a link flow control device for communicating with the output interface of the output blocks.

Each of the output blocks for a switch element may also include an arbiter device that schedules the packet flow to the respective output links. For example, the first output block 50 may include a first arbiter device 54 and the second output block 60 may include a second arbiter device 64. Each arbiter device may schedule the packet traffic flow onto a respective output link based on priority, the number of data packets for a class within a local priority queue and the number of data packets for the class within a targeted priority queue. Stated differently, each arbiter device may appropriately schedule the packet traffic flow based on status information at the switch element, status information of the next switch element and a priority level of the class of data. The arbiter devices thereby optimize the scheduling of the data flow. The arbiter device may include control logic and/or state machines to perform the described functions.

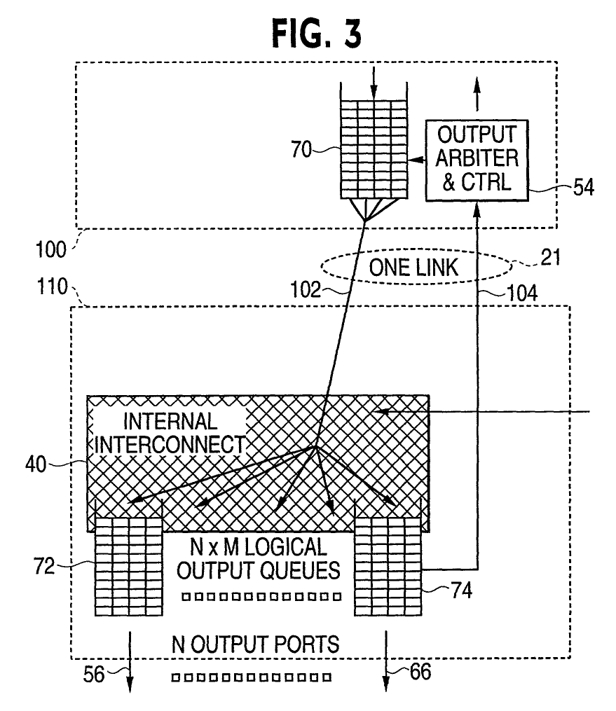

FIG. 3 shows a first switch element 100 coupled to a second switch element 110 by a link 21. The figure only shows one link 21 although the first switch element 100 may have a plurality of output links. The link 21 may allow traffic to flow in two directions as the link may include two signal lines. Each signal line may be for transferring information in a particular direction. FIG. 3 shows the first switch element 100 having data packets within a logical priority queue 70 (also called output queue). The priority queue 70 is shown as an array of queues having a plurality of classes of data along the horizontal axis and targeting a plurality of next switch outputs in the vertical axis. Each class corresponds with a different level of service. The first switch element 100 further includes an arbiter device 54 similar to that described above. The arbiter device 54 schedules the data packet flow from the priority queue 70 across the link 21 to the second switch element 110. The arbiter device 54 selects the next class of data targeting a next switch output from the priority queue to be sent across the link 21. Each selected data packet may travel across the signal line 102 and through the respective input port into the buffer 40 of the second switch element 110. The respective data may then be appropriately placed within one of the priority queues 72 or 74 of the second switch element 110 based on the desired output port. Each of the priority queues 72 or 74 may be associated with a different output port. For example, the data packets received across the signal line 102 may be routed to the priority queue 72 associated with the output port coupled to the link 56 or to the priority queue 74 associated with the outport port coupled to the link 66. As discussed above, the arbiter device 54 may appropriately schedule the data packet flow from the first switch element 100 to the second switch element 110. The second switch element 110 may then appropriately route the data packet into one of the respective data queues, such as the priority queue 72 or the priority queue 74. At the appropriate time, the second switch element 110 may output the data along one of the output links such as the link 56 or the link 66. It is understood that this figure only shows two output ports coupled to two output links, although the second switch element 110 may have a plurality of output ports coupled to a plurality of output links.

FIG. 3 further shows a feedback signal 104 that is transmitted from the second switch element 110 to the first switch element 100 along another signal line of the link 21. The feedback signal 104 may be output from a queue monitoring circuit (not shown in FIG. 3) within the second switch element 110 and be received at the arbiter device 54 of the first switch element 100 as well as any other switch elements that are coupled to the input ports of the second switch element 110. In this example, the feedback signal 104 is transmitted to the arbiter device 54 of the first switch element 100.

The feedback signal 104 that is transmitted from the second switch element 110 to the first switch element 100 may include queue status information about the second switch element 110. That is, status information of the second switch element 110 may be communicated to the first switch element 100. The feedback signal 104 may be transmitted when status changes regarding one of the classes within one of the priority queues of the second switch element 100. For example, if the number of data packets (i.e., the depth level) for a class changes with respect to a watermark (i.e., a predetermined value or threshold) then the queue monitoring circuit of the second switch element 110 may transmit the feedback signal 104 to the first switch element 100. The watermark may be a predetermined value(s) with respect to the overall capacity of each of the priority queues as will be discussed below. In one example embodiment, a watermark may be provided at a 25% level, a 50% level and a 75% level of the full capacity of the queue for a class. Thus, the feedback signal 104 may be transmitted when the number of data packets (i.e., the depth of the queue) for a class goes higher or lower than the 25% level, the 50% level and/or the 75% level. The feedback signal 104 may also be transmitted at other times including at random times.

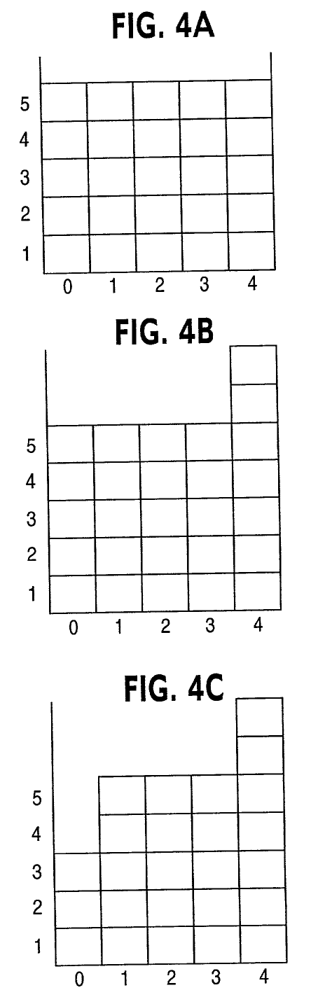

FIGS. 4A-4C show three different examples of priority queues. The horizontal axis of each priority queue may represent the particular class such as class 0, class 1, class 2, class 3 and class 4. Each class corresponds with a different level of service. The vertical axis of each priority queue may represent the number (i.e., the depth or level) of the data packets for a class. FIG. 4A shows that each of the five classes 0-4 have five data packets within the priority queue. If two additional data packets from class 4 are received at the switch element, then the status of the priority queue may change as shown in FIG. 4B. That is, there may now be seven data packets for class 4 within the priority queue. Each of the classes 0-3 may still have five data packets within the priority queue since no data packets have been added or removed from the priority queue for those classes. If the addition of these two data packets for class 4 makes the amount of data packets for class 4 change with respect to a watermark of class 4 (i.e., go greater than or less than a 25% watermark, a 50% watermark or a 75% watermark), then the arbiter device (or queue monitoring circuit) may transmit a feedback signal. Stated differently, if a watermark exists at a level of six and the number of data packets increases from five to seven, then the status of that class has changed with respect to a watermark (i.e., the number of data packets has gone greater than six) and a feedback signal may be transmitted indicating the status at that switch element. Status may include an indication of whether the number of data packets for a class is greater than a high mark, between a high mark and a mid-mark, between a mid-mark and a low mark and below a low mark.

FIG. 4C shows the priority queue after two data packets have been removed (i.e., been transmitted) from the priority queue for class 0. That is, there may now be three data packets for class 0 within the priority queue, five data packets for each of the classes 1-3 within the priority queue, and seven data packets for the class 4 within the priority queue. The removal of two data packets from the priority queue for class 0 may cause the arbiter device to output a feedback signal if the number of data packets in the priority queue for class 0 changes with respect to a watermark.

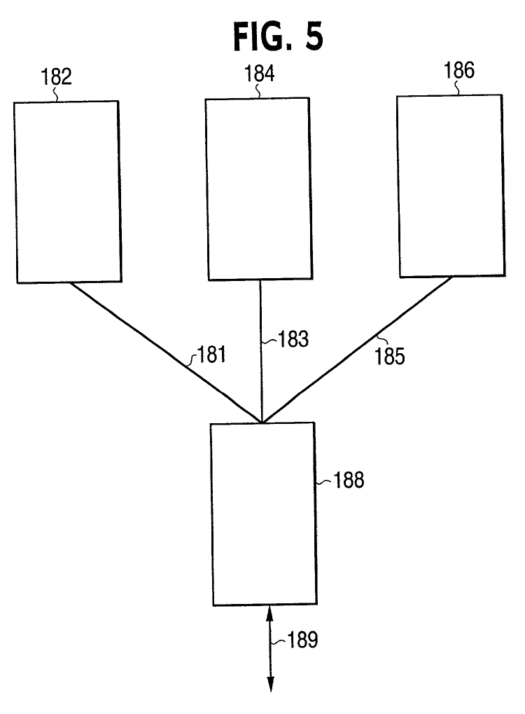

FIG. 5 shows four switch elements coupled together in accordance with one example arrangement. A first switch element 182 may be coupled to the second switch element 188 by a first link 181. A third switch element 184 may be coupled to the second switch element 188 by a second link 183 and a fourth switch element 186 may be coupled to the second switch element 188 by a third link 185. Each of the links 181, 183 and 185 are shown as a single signal line although each link may include two signal lines, one for transmitting information in each of the respective directions. That is, the link 181 may include a first signal line that transmits information from the first switch element 182 to the second switch element 188 and a second signal line that transmits information from the second switch element 188 to the first switch element 182. A link 189 may also couple the second switch element 188 with other switch elements or with other peripheral devices.

Data may be transmitted from the first switch element 182 to the second switch element 188 along the link 181. Based on this transmission, the number of data packets for a class within the priority queue in the second switch element 188 may change with respect to a watermark for that class. If the status changes with respect to a watermark, then the second switch element 188 may transmit a feedback signal, such as the feedback signal 104, to each of the respective switch elements that are coupled to the input ports of the second switch element 188. In this example, the feedback signal 104 may be transmitted from the second switch element 188 to the first switch element 182 along the link 181, to the third switch element 184 along the link 183, and to the fourth switch element 186 along the link 185.

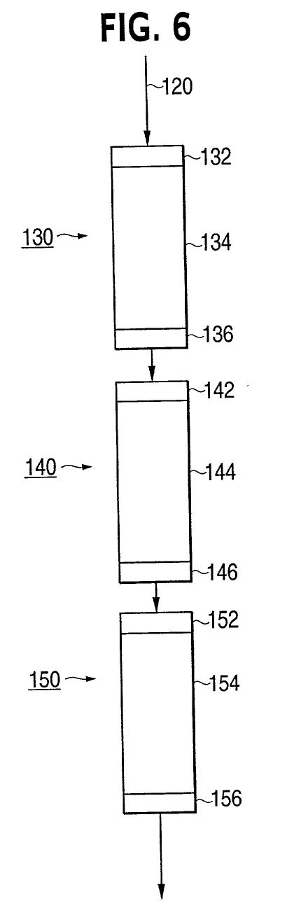

FIG. 6 shows the data propagation and flow control information that may be transmitted between different switch elements along a link 120. FIG. 6 only shows a single signal line with the data flowing in one direction. The link 120 may include another signal line to transmit information in the other direction. In this example, three sets of data, namely first data 130, second data 140 and third data 150 are transmitted along the signal line 120 from a first switch element (not shown) to a second switch element (not shown). The first data 130 may include a data packet 134 and delimiters 132 and 136 provided on each side of the data packet 134. Similarly, the second data 140 may include a data packet 144 and delimiters 142, 146 provided on each side of the data packet 144. Still further, the third data 150 may include a data packet 154 and delimiters 152 and 156 provided on each side of the data packet 154. Flow control information may be provided between each of the respective sets of data. The flow control information may include the feedback signal 104 as discussed above. For example, the feedback signal 104 may be provided between the delimiter 136 and the delimiter 142 or between the delimiter 146 and the delimiter 152.

As discussed above, the feedback signal 104 may be sent when the status (i.e., a level within the priority queue) of a class within the priority queue changes with respect to a watermark (i.e., a predetermined value or threshold) such as 25%, 50% or 75% of a filled capacity for that class. The feedback signal 104 may be a status message for a respective class or may be a status message for more than one class. In one example embodiment, the status message that is sent from one switch element to the connecting switch elements includes a status indication of the respective class. This indication may correspond to the status at each of the output ports of the switch element. In other words, if the switch element includes eight output ports, then the feedback signal for a particular class may include status information regarding that class for each of the eight output ports. The status indication may indicate whether the number of data packets is greater than a high mark, between the high mark and a mid-mark, between a mid-mark and a low mark or below the low mark.

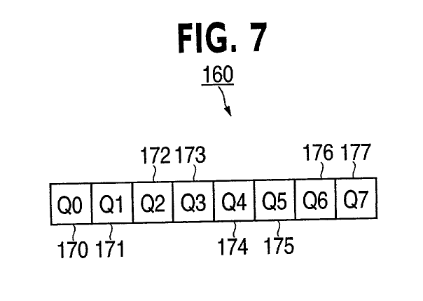

FIG. 7 shows one arrangement of the flow control information (i.e., the feedback signal 104) that may be sent from one switch element to other switch elements. In FIG. 7, the flow control information 160 may include eight 2-bit sets of information that will be sent as part of the flow control information. For example, the flow control information 160 may include the 2-bit sets 170-177. That is, the set 170 includes two bits that correspond to the status of a first output port Q0. The set 171 may correspond to two bits for a second output port Q1. The set 172 may correspond to two bits for a third output port Q2, the set 173 may correspond to two bits for a fourth output port Q3, the set 174 may correspond to two bits for a sixth output port Q5, the set 176 may correspond to two bits for a seventh output port Q6 and the set 177 may correspond to two bits for an eighth output port Q7. The flow control information 160 shown in FIG. 7 is one example arrangement. Other arrangements of the flow control information and the number of bits of information are also possible.

In one arrangement, the two bits correspond to the status of that class for each output port with relation to the watermarks. For example, if a class has a capacity of 100 within the priority queue, then a watermark may be provided at a 25% level (i.e., low level), a 50% level (i.e., mid level) and a 75% level (i.e., high level). If the arbiter device determines the depth (i.e., the number of data packets) of the class to below the low mark (i.e., below the 25% level), then the two bits may be 00. If the number of data packets for a class is between the low mark and the mid-mark (i.e., between the 25% level and the 50% level), then the two bits may be 01. If the number of data packets for a class is between the mid-mark and the high mark (i.e., between the 50% and 75% level), then the two bits may be 10. Similarly, if the number of data packets for a class is above the high mark (i.e., above the 75% level), then the two bits may be 11. The watermark levels may be at levels other than a 25% level, a 50% level and a 75% level.

Stated differently, the flow control information, such as the feedback signal 104, may include status of the class for each output port. Thus, the information sent to the other switch elements may include the status of each output port for a respective class. The status information may be the two bits that show the relationship of the number of data packets with respect to a low mark, a mid-mark and a high mark.

As discussed above, the arbiter device may send a feedback signal to all the switch elements that are coupled to input links of that switch element. Each of the arbiter devices of the switch elements that receive the feedback signal 104 may then appropriately schedule the traffic on their own output ports. For example, with respect to FIG. 5, the feedback signal 104 may be transmitted to each of the switch elements 182, 184 and 186. Each of the first switch element 182, the third switch element 184, and the fourth switch element 186 may then appropriately determine the next data packet it wishes to propagate from the priority queue.

In deciding which class of data to propagate next, each arbiter device may perform an optimization calculation based on the priority class of the traffic, the status of the class in the local queue, and the status of target queue in the next switch element (i.e., the switch element that will receive the data packets). The optimization calculation may use the priority level of each class as the base priority, add to that a forward pressure term calculated from the status of the corresponding local queue, and then subtract a back pressure term calculated from the status of the target queue in the next switch (i.e., transmit priority=base priority+forward pressure−back pressure). That is, the arbiter device may contain an algorithm for optimizing the transmitting order. Using the FIG. 3 example, the arbiter for link 102 may perform a calculation for head packet in each class in the priority queue 70 that adds the priority of the class to the forward pressure term for the corresponding class in the priority queue 70 and subtracts the back pressure term for the corresponding class in the target priority queue 72, 74 in the next switch element. As can be seen, the status of both the local queue and the target queue may be 0, 1, 2 or 3 based on the relationship of the number of data packets as compared with the low mark, the mid-mark and the high mark. The status 0, 1, 2, or 3 may correspond to the two bits of 00,01, 10 and 11, respectively. After performing the optimization calculation for each of the classes, the arbiter device may then select for transmission the class and target next switch output that receives the highest value from this optimization calculation. Data for the class and target next switch output that has the highest value may then be transmitted from the first switch element 100 to the second switch element 110 along the link 102. Referring to FIG. 5, the arbiter device in each of the switch elements 182, 184, 186 may separately perform the optimization calculations for each of the classes in order to determine which data packets to send next. As discussed above, if the switch element 188 receives data packets and the status of one of its queues changes, then the feedback signal 104 may be transmitted along the link 181 to switch element 182, along the link 183 to switch element 184 and along the link 185 to switch element 186.

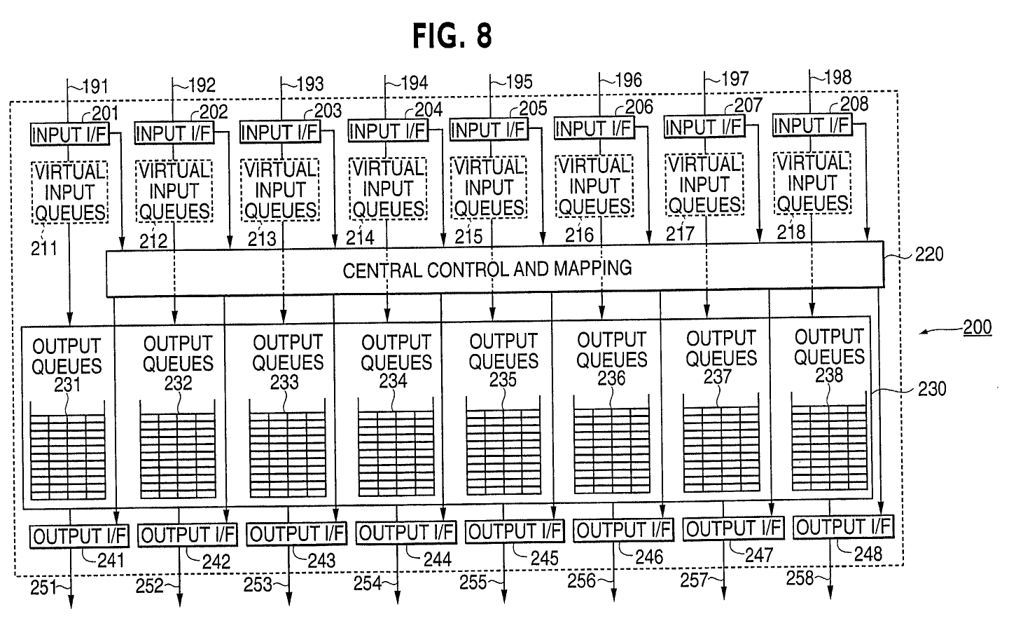

FIG. 8 shows an architecture of one switch element (or switch component) according to an example embodiment of the present invention. This figure and its discussion are merely illustrative of one example embodiment. That is, other embodiments and configurations are also within the scope of the present invention.

FIG. 8 shows a switch element 200 having eight input links 191-198 and eight output links 251-258. Each of the input links 191-198 is coupled to a corresponding input interface 201-208. Each of the input interfaces 201-208 may be associated with a virtual input queue 211-218. Each input interface 201-208 may be coupled to a central control and mapping module 220. The central control and mapping module 220 may be similar to the control block described above with respect to FIG. 2.

The switch element 200 also includes a central buffer (i.e., RAM) 230 that is provided between the input interfaces 201-208 and a plurality of output interfaces 241-248. The central buffer 230 may be coupled to share its memory space among each of the output interfaces 241-248. That is, the total space of the central buffer 230 may be shared among all of the outputs. The central control and mapping module 220 may also be coupled to each of the respective output interfaces 241-248, which may be coupled to the plurality of output links 251-258. The central buffer 230 may include a plurality of output queues 231-238, each of which is associated with a respective one of the output interfaces 241-248.

The output queues 231-238 utilize the shared buffer space (i.e., the central buffer 230) and dynamically increase and decrease in size as long as space is available in the shared buffer. That is, each of the output queues 231-238 doesn't need to take up space of the central buffer 230 unless it has data. On the other hand, the virtual input queues 211-218 may be virtual and may be used by the link-level flow control feedback mechanisms to prevent overflowing the central buffer 230 (i.e., the shared buffer space). Embodiments of the present invention provide advantages over disadvantageous arrangements in that they provide output queuing rather than input queuing. That is, in input queuing traffic may backup trying to get to a specific output of a switch element. This may prevent data from getting to another output of the switch element. Stated differently, traffic may back up and prevent data behind the blocked data from getting to another queue.

As shown in FIG. 8, there may be one input interface for each input port. That is, each of the input interfaces 201-208 is associated with one input port 191-198. Each of the input interfaces 201-208 may receive data packets across its attached link coupled to a previous switch element. Each of the input interfaces 201-208 may also control the storing of data packets as chains of elements in the central buffer 230. The input interfaces 201-208 may also pass chain head pointers to the central control and mapping module 220 to appropriately output and post on appropriate output queues.

FIG. 8 shows that each input link (or port) may be associated with a virtual input queue. As discussed above, the virtual input queues 211-218 are virtual buffers for link-level flow control mechanisms. As will be explained below, each virtual input queue represents some amount of the central buffer space. That is, the total of all the virtual input queues 211-218 may equal the total space of the central buffer 230. Each virtual input queue 211-218 may put a limit on the amount of data the corresponding input interface allows the upstream component to send on its input link. This type of flow control may prevent overflow of data from the switch element and thereby prevent the loss of data. The output queues may thereby temporarily exceed their allotted capacity without the switch element losing data. The virtual input queues 211-218 thereby provide the link level flow control and prevent the fabric from losing data. This may ensure (or minimize) that once data is pushed into the switch fabric that it won't get lost. Link level flow control prevents overflow of buffers or queues. It may enable or disable (or slow) the transmission of packets to the link to avoid loss of data due to overflow.

The central control and mapping module 220 may supply empty-buffer element pointers to the input interfaces 201-208. The central control and mapping module 220 may also post packet chains on the appropriate output queues 231-238.

The central buffer 230 may couple the input interfaces 201-208 with the output interfaces 241-248 and maintain a multi-dimensional dynamic output queue structure that has a corresponding multi-dimensional queue status array as shown in FIG. 8. The queue array may be three-dimensional including dimensions for: (1) the number of local outputs; (2) the number of priorities (or logical paths or virtual lanes); and (3) the number of outputs in the next switch element. The third dimension of the queue adds a queue for each output in the next switch element downstream. Each individual queue in the array provides a separate path for data flow through the switch. The control buffer 230 may enable the sharing of buffer space (i.e., the central buffer 230) between all the currently active output queues 231-238.

The three dimensions of the multi-dimensional queue array will now be discussed briefly. The first dimension relates to the number of outputs in the switch element. Thus, each output in the switch element has a two dimensional set of queues. The second dimension relates to the number of logical paths (or virtual lanes) supported by the switch element. Thus, each output has a one dimensional set of queues for each virtual lane it supports. Each physical link can be logically treated as having multiple lanes like a highway. These “virtual” lanes may provide more logical paths for traffic flow which enables more efficient traffic flow at interchanges (i.e., switches) and enables prioritizing some traffic over others. The third dimension relates to the number of outputs in the target component for each local output. Thus, each virtual lane at each local output has a queue for each of the outputs in the target component for that local output. This may enable each output arbiter device to optimize the sequence packets are transmitted so as to load balance across virtual lanes and outputs in its target component.

Each output port may also be associated with a single output interface. Each of the output interfaces 241-248 may arbitrate between multiple logical output queues assigned to its respective output port. The output interfaces 241-248 may also schedule and transmit packets on their respective output links. The output interfaces 241-248 may return buffer element pointers to the central control and mapping module 220. Additionally, the output interfaces 241-248 may receive flow/congestion control packets from the input interfaces 201-208 and maintain arbitration and schedule control states. The output interfaces 241-248 may also multiplex and transmit flow/congestion control packets interleaved with data packets.

By using the above described switch architecture, several advantages may be achieved. For example, larger port counts in a single switch element (or component) may be constructed as multiple interconnected buffer sharing switch cores using any multi-stage topology. The internal congestion control may enable characteristics of a single monolithic switch. Further, the architecture may support differentiated classes of service, full-performance deadlock-lock-free fabrics and may be appropriate for various packet switching protocols. Additionally, the buffer sharing (of the central buffer 230) may enable queues to grow and shrink dynamically and allow the total logical queue space to greatly exceed the total physical buffer space. The virtual input queues 211-218 may support standard link level flow control mechanisms that prevent packet discard or loss due to congestion. Further, the multi-dimensional output queue structure may support an unlimited number of logical connections through the switch and enable use of look-ahead congestion control.

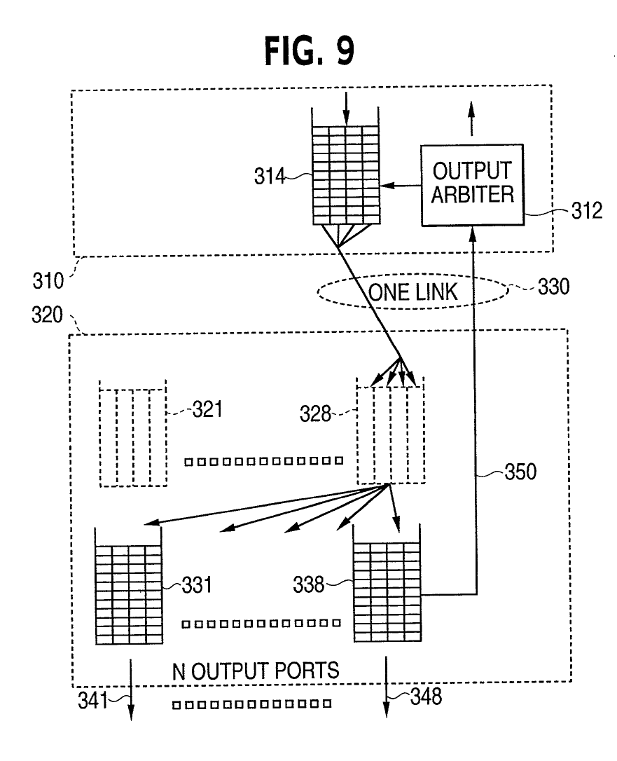

FIG. 9 shows a first switch element 310 coupled to a second switch element 320 by a link 330 according to an example embodiment of the present invention. Other configurations and embodiments are also within the scope of the present invention. This embodiment has an integration of look-ahead congestion control and link level flow control. The flow control mechanism protects against the loss of data in case the congestion control gets overwhelmed. The figure only shows one link 330 although the first switch element 310 may have a plurality of links. The link 330 may allow traffic to flow in two directions as shown by the two signal lines. Each signal line may be for transferring information in a particular direction as described above with respect to FIG. 3. FIG. 9 shows that the first switch element 310 has data packets within a logical output queue 314. The first switch element 310 may include (MxQ) logical output queues per output, where M is the number of priorities (or logical paths) per input/output (I/O) port and Q is the number of output ports (or links) out of the next switch element (i.e., out of switch element 320). For ease of illustration, these additional output queues are not shown.

In a similar manner as described above with respect to FIG. 3, an arbiter 312 may schedule the data packet flow from the output queue 314 (also referred to as a priority queue) across the link 330 to the second switch element 320. The arbiter 312 may also be referred to as an arbiter device or an arbiter circuit. Each output queue array 314 may have a corresponding arbiter 312. The arbiter 312 may select the next class of data targeting a next switch output from the queue array to be sent across the link 330. Each selected data packet may travel across the signal line and through the respective input port into the second switch element 320.

As shown, the second switch element 320 includes a plurality of virtual input queues such as virtual input queues 321 and 328. For ease of illustration, only virtual input queues 321 and 328 are shown. The second switch element 320 may include (N×M) virtual input queues, where N is the number of I/O ports (or links) at this switch element and M is the number of priorities (or logical paths) per I/O port. The second switch element 320 may also include a plurality of logical output queues such as logical output queues 331 and 338. For ease of illustration, only the output queues 331 and 338 are shown. For example, the second switch element 320 may include (N×M×Q) logical output queues, where N is the number of I/O ports (or links) at that switch element (or local component), M is the number of priorities (or logical paths) per I/O port and Q is the number of output ports (or links) out of the next switch element (or component).

FIG. 9 further shows a signal 350 that may be sent from the second switch element 320 to the arbiter 312 of the first switch element 310. The signal 350 may correspond to the virtual input queue credits (e.g., for the Infiniband Architecture protocol) or virtual input queue pauses (e.g., for the Ethernet protocol), plus the output queue statuses. The local link level flow control will now be described with respect to either credit based operation or pause based operation. Other types of flow control may also be used for the link level flow control according to the present invention.

The credit based operation may be provided within Infiniband or Fibre Channel architectures, for example. In this type of architecture, the arbiter 312 may get initialized with a set of transmit credits representing a set of virtual input queues (one for each priority or logical path) on the other end of the link such as the link 330. The central buffer 230 (FIG. 8) may be conceptually distributed among the virtual input queues 321-328 for flow control purposes. The arbiter 312 may schedule transmission of no more than the amount of data for which it has credits on any given virtual input queue. When the packets are transmitted to the second switch element 320 over the downstream link, then the equivalent credits are conceptually sent along. When those same packets are subsequently transmitted from the second switch element 320, then their corresponding credits are returned via flow control packets over the upstream link such as by the signal 350. The return credits replenish the supply and enable the further transmission. Other types of credit based link level flow control are also within the scope of the present invention.

A pause based link level flow control will now be described. The pause based link level flow control may be applicable to Ethernet architectures, for example. In this architecture, each of the input interfaces may be initialized with virtual input queues. Each virtual input queue may be initialized with a queue size and a set of queue status thresholds and have a queue depth counter set to zero. When a packet conceptually enters a virtual input queue, the queue depth may be increased. When the packet gets transmitted out of the switch element, the queue depth may be decreased. When the queue depth exceeds one of the status thresholds, pause messages may be transmitted over the upstream link (such as the signal 350) at a certain rate with each message indicating a quanta of time to pause transmission of packets to the corresponding virtual input queue. The higher the threshold (i.e., the more data conceptually queued), the higher the frequency of pause messages, the longer the pause times, and the slower transmission to that queue. When a virtual input queue is conceptually full, the rate of pause messages and the length of the pause time should stop transmission to that queue. On the other hand, each time a queue depth drops below a threshold, then the corresponding pause messages may decrease in frequency and pause time, and increased transmission to the corresponding queue may be enabled. When the queue depth is below the lowest threshold, then the pause messages may cease. Other types of pause based link level flow control are also within the scope of the present invention.

In at least one embodiment, the virtual input queues 211-218 may be represented by a credit count for each input to the switch element 200. The credit count for each input may be initialized to B/N where B is the size of the total shared buffer space (i.e., the size the central buffer 230) and N is the number of inputs to the switch element 200. When a data packet is received at the switch element, it may be sent directly to the appropriate output queue in the central buffer 230. However, the size of the space it consumes in the central buffer 230 may be subtracted from the credit count for the input on which it arrived. When that same packet is transmitted from the switch element 200 to the next switch element, the size of the space it vacated in the central buffer 230 is added back into the credit count for the input on which it had previously been received. Each link receiver uses its current credit count to determine when to send flow control messages to the transmitting switch element (i.e., the previous switch element) at the other end of the link to prevent the transmitting switch element from assuming more than its share of the shared buffer space (i.e., the initial size of the virtual input queues). Accordingly, if the input receiver does not consume more than its share of the shared buffer space, then the central buffer 230 will not overflow.

For certain architectures such as Infiniband, each input link may have more than one virtual lane (VL) and provide separate flow control for each virtual lane. For each input link, there may be L virtual input queues, where L is the number of virtual lanes. Thus, the total number of virtual input queues is N×L and the initial size of each virtual input queue (or credit count) may be (B/N)/L.

Local link level congestion control will now be described with respect to a look-ahead mechanism. Link level congestion control may optimize the sequence that packets are transmitted over a link in an attempt to avoid congesting queues in the receiving component. This mechanism may attempt to load balance across destination queues according to some scheduling algorithm (such as the pressure function as will be described below). The look-ahead mechanism may include a three dimensional queue structure of logical output queues for the central buffer 230 in each switch element. The three dimensional array may be defined by: (1) the number of local outputs; (2) the number of priorities (or logical paths); and (3) the number of outputs in the next switch element along yet another axis. Queue sizes may be different for different priorities (or logical paths). The total logical buffer space encompassed by the three dimensional array of queues may exceed the physical space in the central buffer 230 due to buffer sharing economies. As such, a set of queue thresholds (or watermarks) may be defined for each different queue size such as a low threshold, a mid threshold and a high threshold. These thresholds may be similar to the 25%, 50% and 75% thresholds discussed above. A three dimensional array of status values may be defined to indicate the depth of each logical queue at any given time. For example, a status of “0” may indicate that the depth is below the low threshold, a status of “1” may indicate that the depth is between the low threshold and the mid threshold, a status of “2” may indicate that the depth is between the mid threshold and the high threshold and a status of “3” may indicate that the depth is above the high threshold. These status may be represented by two bits as discussed above.

Each time that the depth of the queue crosses one of the thresholds, the status for that priority (or logical path) on all the local outputs may be broadcast to all the attached switch components using flow control packets. Stated differently, whenever the status changes with respect to a watermark, then status messages of a set of queues (for a switch element) may be broadcast back to all components that can transmit to this switch element. The feedback comes from a set of output queues for a switch element rather than from an input queue. The flow control information is thereby sent back to the transmitters of the previous switch elements or other components. This may be seen as the signal 350 in FIG. 9. Each arbiter may arbitrate between the queues in a two dimensional slice of the array (priorities or logical paths by next switch component outputs) corresponding to its local output. It may calculate a transmit priority for each queue with a packet ready to transmit. The arbiter may also utilize the current status of an output queue, the priority offset of its logical queue and the status of the target queue in the next component to calculate the transmit priority. For each arbitration, a packet from the queue with the highest calculated transmit priority may be scheduled for transmission. An arbitration mechanism such as round robin or first-come-first-served may be used to resolve ties for highest priority.

A three dimensional output queuing structure within a switch element has been described that may provide separate queuing paths for each local output, each priority or logical path and each output in the components attached to the other ends of the output links. A buffer sharing switch module may enable implementation of such a queuing structure without requiring a large amount of memory because: 1) only those queues used by a given configuration utilize queue space; 2) flow and congestion controls may limit how much data actually gets queued on a given queue; 3) as traffic flows intensify and congest at some outputs, the input bandwidth may be diverted to others; and 4) individual queues can dynamically grow as long as buffer space is available and link level flow control prevents overflow of the central buffer 230.

The virtual input queues may conceptually divide the total physical buffer space among the switch inputs to enable standard link level flow control mechanisms and to prevent the central buffer 230 from overflowing and losing packets. Feedback of the queue status information between switch components enables the arbiters in the switch elements to factor downstream congestion conditions into the scheduling of traffic. The arbiters within a multi-stage fabric may form a neural type network that optimizes fabric throughput and controls congestion throughout the fabric by each participating and controlling congestion and optimizing traffic flow in their local environments.

Scheduling by round-robin or first-come-first-served type of mechanisms may be inadequate for congestion control because they do not factor in congestion conditions of local queues or downstream queues. As such, embodiments of the present invention may utilize an arbitration algorithm for look-ahead congestion control.

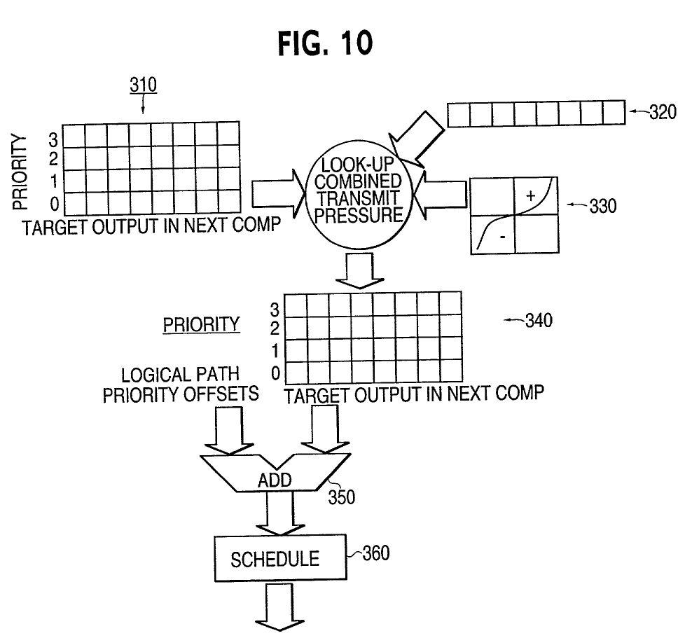

An arbitration algorithm for look-ahead congestion control will now be described with respect to FIGS. 10-12. More specifically, FIG. 10 shows the functionality of an arbiter according to an example embodiment of the present invention. Other functionalities for the arbiter (or similar type of circuit) are also within the scope of the present invention. The arbiter may include the mechanism and means for storing an array 310 of local queue statuses as well as receiving a status message 320 from a next switch element (i.e, the downstream switch element). The array 310 of local queue statuses for each respective output port may be a two dimensional array with one dimension relating to the priority (or virtual lane) and another dimension relating to the target output in the next switch element. The arbiter may receive the status message 320 from the next switch element as a feedback element (such as feedback signal 104 or signal 350). The status message 320 may correspond to a one-dimensional row containing data associated with the target outputs in the next switch element for one priority level (or virtual lane). The array 310 and the status message 320 may be combined, for example, by the status message 320 being grouped with a corresponding horizontal row (or the same priority or virtual lane) from the array 310. As one example, data associated with the bottom row of the array 310 having a priority level 0 may be combined with the status message 320 of a priority level 0. A transmit pressure function 330 may be used to determine transmit pressure values for the combined data. Each combined data may be an element within a transmit pressure array 340. That is, the array 310 may be combined with four separate status messages 320 (each of different priority) from the next switch element and with the transmit pressure function 330 to obtain the four rows of the transmit pressure array 340, which correspond to the priorities 0-3. These transmit pressure values may be determined by using the transmit pressure function 330. The transmit pressure function 330 may correspond to values within a table stored in each arbiter circuit or within a common area accessible by the different arbiters. Stated differently, a transmit pressure array 340 may be determined by using: (1) an array 310 of local queue statuses; (2) status messages 320 from the next switch element; and (3) a transmit pressure function 330. For each local or next switch component change, the transmit pressure array 340 may be updated.

Logical path priority offsets may be added to values within the transmit pressure array 340 (in the block labeled 350). The arbiter may then appropriately schedule the data (block labeled 360) based on the highest transmit pressure value. Stated differently, for each arbitration, the local output queues may be scanned and the transmit priorities my be calculated using the logical path priority offsets and pressure values. The packet scheduled next for transmission to the next switch element may be the packet with the highest calculated transmit priority.

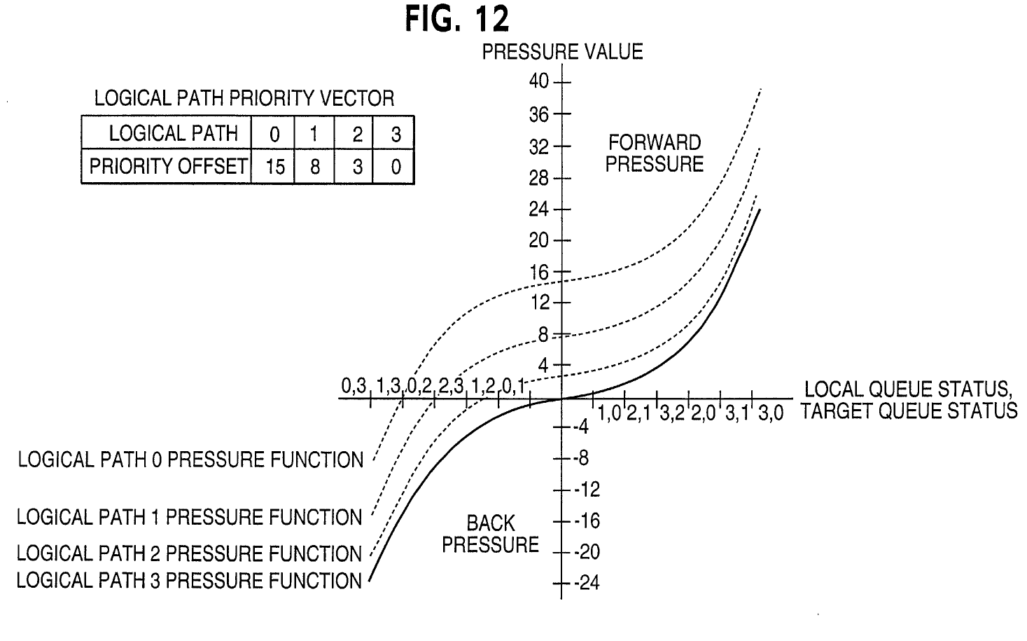

Further functionality of the arbiter will now be described with respect to positive and negative pressures. A status of a local output queue may exert a positive pressure and a status of a target output queue in the next switch element may exert a negative pressure. Embodiments of the present invention may utilize values of positive pressure and negative pressure to determine the pressure array 340 and thereby determine the appropriate scheduling so as to avoid congestion. The logical path priority may skew the pressure function (such as the transmit pressure function 330) upward or downward as will be shown in FIG. 12. Furthermore, the pressure array 340 may be updated each time a local queue status changes or a status message of a next switch element message is received.

In at least one arbitration sequence, all local queues may be scanned starting with the one past the last selected (corresponding to a round-robin type of selection). For each local output queue with packets ready to send, the transmit priority may be calculated using the current pressure value with the logical path priority offset. If the results are higher than the previous analysis, then a queue identification and priority results may be saved. When all the priority queues are considered, the queue identified having the highest transmit priority may be enabled to transmit its next packet.

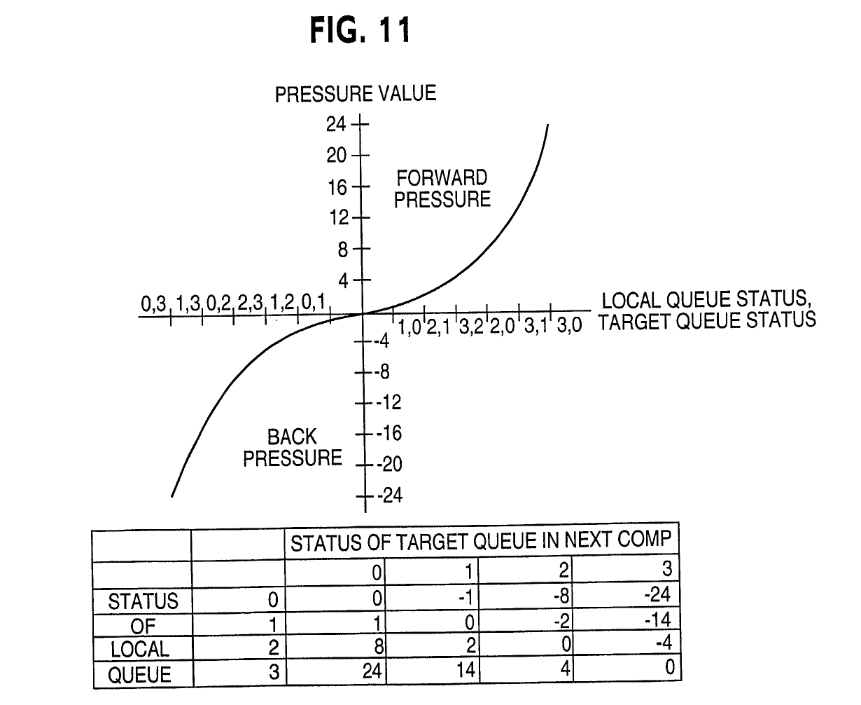

FIG. 11 shows an example pressure function within the arbiter according to an example embodiment of the present invention. Each individual local queue may have a pressure value associated with it at all times. The pressure value for a local queue may be updated each time either the local queue status or the status of its target virtual lane and output in the next component changes. Each mark on the X axis of the graph is labeled with a combination of “local status, target status”. Each mark in the Y axis corresponds to a pressure value. The table at the bottom of the figure lists the pressure values for each combination of “local, target” status. The curve graphs the contents of the table. Negative pressure (or back pressure) for a given output queue reduces its transmit priority relative to all other output queues for the same local output. Positive pressure (or forward pressure) increases its transmit priority. FIG. 12 shows that the priority of the logical path (virtual lane) for a given output queue may skew its pressure value by a priority offset to determine its transmit priority. Each output arbiter (or scheduler) may choose the output queue with the highest transmit priority (and resolve ties with a round-robin mechanism) for each packet transmission on its corresponding link.

The pressure curve may have any one of a number of shapes. This shape of FIG. 11 was chosen because it has excellent characteristics, and because it tends to react quickly to large differentials between queue statuses and slowly to small differentials. As discussed above, in this figure, the vertical axis corresponds to a pressure value whereas the horizontal axis corresponds to the local queue status and the target queue status. When the local and target statuses are equal, then the combined pressure may be zero as shown in the graph. When the statuses are different between the local and target statuses, then either forward or back pressure may be exerted depending on which status (i.e., local status or target status) is greater. The forward or back pressure may be determined based on the status of the local output queue and the target output queue. The higher the congestion level, the greater the pressure changes caused by the status change. This pressure function may be contained within a look-up table provided in the arbiter or other mechanisms/means of the switch element. Other examples of a pressure function for the arbiter are also within the scope of the present invention. The pressure function may also be represented within a mechanism that is shared among different arbiters.

FIG. 12 shows a logical path priority function according to an example embodiment of the present invention. Other examples of a logical path priority function are also within the scope of the present invention. This priority function is similar to the pressure function shown in FIG. 11 and additionally includes offsets based on the corresponding priority. FIG. 12 shows a logical path 0 pressure function, a logical path 1 pressure function, a logical path 2 pressure function and a logical path 3 pressure function. Along the vertical axis, each of the graphs is offset from the center coordinate (0,0) by its corresponding priority offset.

Each logical path may be assigned a priority offset value. Different logical paths will occur for different types of traffic. For example and as shown in FIG. 12, the priority offset for data file backups may be zero, the priority offset for web traffic may be three, the priority offset for video and other real-time data may be eight and the priority offset for voice may be fifteen. The logical path priority function may be combined with the priority offset to determine the appropriate priority queue to be transmitted to the next switch element in a manner as discussed above. That is, during the output arbitration, the priority offset value may be added to the pressure value as shown in block 350 (FIG. 10) to calculate the transmit priority. The priority offset effectively skews the pressure function up or down the vertical axis.

All the arbiters within a multi-stage switch fabric may form a neural type network that controls congestion throughout the fabric by each participating in controlling congestion in its local environment. The local environment of each arbiter may overlap several environments local to other arbiters in a given stage of the fabric such that all the arbiters in that stage cooperate in parallel to control congestion in the next downstream stage. Congestion information in the form of output queue statuses may be transmitted upstream between stages and enable modifying (i.e, optimizing) the scheduling of downstream traffic to avoid further congesting the congested outputs in the next stage. The affect of modifying the scheduling out of a given stage may propagate some of the congestion back into that stage and thereby help to relieve the downstream stage but possibly causing the upstream stage to modify its scheduling and thereby absorb some of the congestion. Thus, changes in congestion may propagate back against the flow of traffic causing the affected arbiters to adjust their scheduling accordingly. Even though a given arbiter only has information pertaining to its own local environment, all the arbiters may cooperate both vertically and horizontally to avoid excessive congestion and to optimize the traffic flow throughout the fabric. The output arbitration, pressure, and priority offset functions may ultimately determine how effectively overall traffic flow is optimized. These functions may be fixed or dynamically adjusted through a learning function for different loading condition.

While the invention has been described with respect to the specific embodiments, the description of the specific embodiments is illustrative only and is not considered to be limiting the scope of the present invention. That is, various other modifications and changes may occur to those skilled in the art without departing from the spirit and scope of the invention.

What is claimed is:

1. A switch element comprising:
a plurality of input interfaces to receive data;
a plurality of output interfaces to transmit said data; and
a buffer to couple to said plurality of input interfaces and to said plurality of output interfaces, the buffer including a multi-dimensional array of output queues to store said data, wherein said multi-dimensional array of output queues is shared by said plurality of output interfaces.

2. The switch element of claim 1, wherein said multi-dimensional array of output queues comprise a three-dimensional array of output queues.

3. The switch element of claim 2, wherein said three-dimensions comprise:
a) a first dimension relating to a number of outputs on said switch element;
b) a second dimension relating to a number of logical paths for said data; and
c) a third dimension relating to a number of outputs from a next switch element.

4. The switch element of claim 3, wherein said logical paths are assigned priority levels.

5. The switch element of claim 1, wherein said multi-dimensional array of output queues share space of said buffer.

6. The switch element of claim 1, further comprising a plurality of virtual input queues, wherein each virtual input queue represents a portion of said buffer.

7. The switch element of claim 1, further comprising an arbiter to select data for transmission of said data to a downstream element.

8. The switch element of claim 7, wherein said arbiter selects said data based on status information at said switch element.

9. The switch element of claim 8, wherein a queue status monitor transmits a feedback signal from said switch element to a plurality of upstream switch elements, said feedback signal comprising status information of output queues of said switch element.

10. The switch element of claim 8, wherein said arbiter selects said data by utilizing transmit pressure information.

11. A switch fabric network for transmitting data, said network comprising:
a first switch element; and
a second switch element coupled to said first switch element, said second switch element comprising:
a plurality of input interfaces to receive data from at least said first switch element;
a plurality of output interfaces to transmit said data; and
a buffer to couple to said plurality of input interfaces and to said plurality of output interfaces, the buffer including a multi-dimensional array of output queues to store said data, wherein said multi-dimensional array of output queues is shared by said plurality of output interfaces.

12. The switch fabric network of claim 11, wherein said multi-dimensional array of output queues comprise a three-dimensional array of output queues.

13. The switch fabric network of claim 11, said second switch element further comprising a plurality of virtual input queues, wherein each virtual input queue represents a portion of said buffer.

14. The switch fabric network of claim 11, said second switch element further comprising an arbiter to select data for transmission of said data to a downstream switch element.

15. The switch fabric network of claim 14, wherein said arbiter selects said data by utilizing transmit pressure information.

16. A method of using a switch element in a switch fabric network, said method comprising:
receiving data at an input interface of said switch element;
routing said data to one of a multi-dimensional array of output queues provided within a buffer of said switch element; and
outputting said data from a selected one of said output queues.

17. The method of claim 16, wherein said multi-dimensional array of output queues comprise a three-dimensional arrays of output queues.

18. The method of claim 17, wherein said three-dimensions comprise:
a) a dimension relating to a number of outputs on said switch element;
b) a dimension relating to a number of logical paths for said data; and
c) a dimension relating to a number of outputs from a next switch element.

19. The method of claim 16, wherein said switch element comprises a plurality of virtual input queues, wherein each virtual input queue represents a portion of said buffer.

20. The method of claim 16, further comprising selecting said data in one of said output queues prior to said outputting.

21. The method of claim 20, wherein said data is selected based on status information at said switch element.

22. The method of claim 20, wherein said data is selected by utilizing transmit pressure information.

23. The method of claim 16, further comprising transmitting a feedback signal from said switch element to a plurality of upstream switch elements, said feedback signal comprising status information of output queues of said switch element.

24. A switch element comprising:
a buffer including a multi-dimensional array of output queues to store data; and
an arbiter to select one of said output queues for transmission of data, and a queue status monitor to track the statuses of said multi-dimensional array of said output queues.

25. The switch element of claim 24, wherein said arbiter selects said one of said output queues based on information of said switch element and information of a next switch element.

26. The switch element of claim 25, wherein said arbiter further selects said one of said output queues based on transmit pressure information.

27. The switch element of claim 24, wherein said multi-dimensional array of output queues comprises three-dimensional output queues.

28. The switch element of claim 27, wherein said three-dimensions comprise:
a) a first dimension relating to a number of outputs on said switch element;
b) a second dimension relating to a number of logical paths; and
c) a third dimension relating to a number of outputs from a next switch element.

29. The switch element of claim 24, further comprising a plurality of virtual input queues, wherein each virtual input queue represents a portion of said buffer.

30. The switch element of claim 24, wherein said arbiter selects said one of said output queues based on status information at said switch element.

31. The switch element of claim 24, wherein said queue status monitor transmits a feedback signal from said switch element to a plurality of upstream switch elements, said feedback signal comprising status information of output queues of said switch element.

32. A method of communicating information in a switch element, said method comprising:
receiving data at said switch element;
storing said data in one queue of a multi-dimensional array of output queues in a buffer of said switch element; and
selecting one of said output queues for transmission of data.

33. The method of claim 32, wherein selecting said one of said output queues comprises selecting based on information of said switch element and information of a next switch element.

34. The method of claim 33, wherein said selecting is further based on transmit pressure information.

35. The method of claim 32, wherein said multi-dimensional array of output queues comprises a three-dimensional array of output queues.

36. The method of claim 35, wherein said three-dimensions comprise:
a) a first dimension relating to a number of outputs on said switch element;
b) a second dimension relating to a number of logical paths for said data; and
c) a third dimension relating to a number of outputs from a next switch element.

37. The method of claim 32, wherein said switch element includes a plurality of virtual input queues, wherein each virtual input queue represents a portion of said buffer.

38. The method of claim 32, further comprising transmitting a feedback signal from said switch element to a plurality of upstream switch elements, said feedback signal comprising status information of output queues of said switch element.

39. A switch comprising:
a first output interface associated with a first output link;
a first queue associated with said first output interface; and
a first arbiter associated with said first output interface and said first queue, wherein said first arbiter schedules a next data packet for transmission from said first output interface based on one of a pressure function and a local path priority.

40. The switch of claim 39, wherein said first arbiter schedules said next data packet for transmission from said first output interface based on both said pressure function and said local path priority.

41. The switch of claim 40, wherein said first arbiter schedules said next data packet based on calculated transmit priorities of target queues in a downstream switch.

42. The switch of claim 41, wherein said first arbiter schedules said next data packet relating to a target queue having a highest calculated transmit priority.

43. The switch of claim 39, further comprising a second output interface associated with a second output link, a second output queue associated with said second output interface, and a second arbiter to schedule a next data packet for transmission from said second output interface.

44. The switch of claim 39, wherein said pressure function relates to a relationship of data in said switch and data in a downstream switch.

45. A method of scheduling data traffic from a switch, said method comprising:
determining a transmit priority based on one of a pressure function and a local path priority; and
scheduling data traffic based on said determined transmit priority.

46. The method of claim 45, wherein said determining is based on both said pressure function and said local path priority.

47. The method of claim 45, wherein transmit priority is further determined based on information of target queues in a downstream switch.

48. The method of claim 47, wherein said scheduling comprises selecting a target queue of said downstream switch having a highest calculated transmit priority.

49. The method of claim 45, wherein said pressure function relates to a relationship of data in said switch and data in a downstream switch.
